(19) United States
(12) Patent Application Publication
(10) Pub. No.: US 2007/0281708 A1
(43) Pub. Date: Dec. 6, 2007

(54) System; Arrangements And Method Allowing For Balancing Of Load Between Two Groups Of Dedicated Uplink Channels

(75) Inventors: Martin Bakhuizen, Djursholm (SE); Eva Englund, Linkoping (SE); Patrik Karlsson, Alta (SE); Mats Sagfors, Kyrkslatt (FI)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/719,049

(22) PCT Filed: Nov. 10, 2005
(86) PCT No.: PCT/SE05/01709

§ 371 Date: May 10, 2007

(30) Foreign Application Priority Data
Nov. 10, 2004 (SE) 0402782-7

(51) Int. Cl. H04Q 7/20

(52) U.S. Cl. 455/450

(57) ABSTRACT

A method and a system for balancing load between at least two groups of dedicated uplink channels in a telecommunication network serving a plurality of user equipments (18), wherein scheduling requests received from the user equipments (18) and scheduling grants issued to said user equipments (18) are measured. Thereafter, a measurement report based on the measured scheduling requests and the measured scheduling grants is derived, which is forwarded to a radio network unit (10) controlling radio network resources, whereby a re-distribution of available radio resources is made between the at least two groups of dedicated uplinks channels.

### TECHNICAL FIELD

The present invention relates to a method, a system and arrangements in a Wideband Code Division Multiple Access (WCDMA) communication system, in particular to a system allowing for balancing of load between two groups of dedicated uplink channels, an arrangement in a radio base station for balancing of load and an arrangement in a radio network controller for balancing of load as well as a method for such balancing.

### BACKGROUND OF THE INVENTION

Enhanced uplink for WCDMA is currently being standardized within the Third Generation Partnership Project (3GPP). Among the features introduced is fast scheduling and fast hybrid Automatic Retransmission Request (ARQ) with soft combining, both located in the Node B.

In addition to the Radio Resource Management (RRM) functions such as Admission and Congestion Control (ACC) fast scheduling is introduced in the Node B. Fast scheduling denotes the possibility for the Node B to control when a user equipment is transmitting and at what data rate. Data rate and transmission power is closely related and scheduling can thus also be seen as a mechanism to vary the transmission power used by the User Equipment (UE) for the enhanced uplink traffic on the Enhanced Dedicated Physical Data Channel (E-DPDCH). As the power available in the user equipment at the time of transmission is not known to the Node B, the final selection of data rate has to be performed by the user equipment itself. The Node B only sets an upper limit on the transmission power the user equipment may use on the E-DPDCH. To control the upper limit on the user equipment transmission power from Node B, a number of channels for downlink signalling have been proposed:

Scheduling grant channel: An absolute scheduling grant is transmitted on a shared channel and consists of at least the identity of the UE (or group of user equipments) for which the grant is valid and the maximum resources this user equipment/these user equipments may use.

Relative scheduling grant channel: A relative grant is transmitted on a dedicated resource and consists of (at least) one bit, UP/HOLD/DOWN

Similarly to the uplink in earlier releases of the WCDMA standard, the enhanced uplink uses inner and outer loop power control. The power control mechanism ensures that a UE does not transmit with higher power than required for successful deliver of the transmitted data. This ensures stable system operation and efficient radio resource utilization.

An aspect of particular relevance for this invention is that the resource assignment (scheduling) for non-E-DCH is controlled from the CRNC, while the resource assignment for E-DCH users is to a large extent controlled from the Node B's. This will involve problems with regard to the definition of suitable measurements from the Node B to the CRNC facilitating admission and congestion control of both non-E-DCH and E-DCH channels, and to balance the resource allocation between these two groups; and involve problems regarding the definition of suitable resource control commands from the CRNC to the Node B guiding the Node B scheduling of E-DCH channels. Yet another problem relates to resource balancing between E-DCH and non-E-DCH channels.

Regarding the allocation of E-DCH resources from the CRNC (Controlling Radio network Controller) to the Node B three alternative approaches are known:
1. The CRNC sends a limit on the “Total Power for E-DCH”, which the Node B is allowed to schedule to the E-DCH users. However, this may result in an under-utilization of the available uplink resources, as the E-DCH users are allocated a (semi-) static portion of the available power resources.
2. CRNC sends a limit/target on the “Total UL Power” that the Node B should not exceed when scheduling the E-DCH users. This allows for operating the E-DCH channels so that they utilize all the remaining interference headroom available, which can result in better resource utilization.
3. Both items in the bullets above are used, so that the “Target/Limit of Total UL Power” is mandatory and the “Total Power for E-DCH” is optional. Whichever target is first approached will limit the resources scheduled to E-DCH users.

One challenge with the enhanced uplink is that it has to co-exist with mobiles not supporting the new concept. This means that “older” user equipments will be assigned uplink DCH, and those supporting it will have E-DCH uplink channels. The resource control of DCH is performed from the CRNC, but parts of the E-DCH resource control is performed in the Node B. Thus, there is a need of tools to perform the resource allocation, so that this split resource control is facilitated.

Existing methods include the possibility to assign certain interference bounds for E-DCH and DCH users, respectively. To monitor the current resource use, there are also measurements planned, which indicate how large a fraction of the resources that are used by E-DCH and DCH, respectively. A typical operating scenario is that E-DCH users may use the remaining resources after that DCH have fulfilled their needs.

In a heavily loaded system, there is the situation when not all resource needs can be fulfilled. In such cases, the network must distribute the available resources based on some policy. This policy can be based, e.g., on the transmission needs, priorities (QoS), and possibly on the link quality from the user equipments. The problem in a mixed DCH/E-DCH scenario is that this resource scheduling is distributed between the RNC and the Node B: Thus, the CRNC may lack information on the resource needs expressed by the E-DCH users. The present invention addresses the problem that current measurements on the resource consumption do not facilitate this, because they only tell about the current use, not about the needs.

In such a loaded system, there is then a risk that the CRNC is unaware of the resource needs expressed by the E-DCH users. This could lead to an unfair situation, where DCH users are assigned more resources than their fair share. The DCH may also carry un-prioritised data, and be more resource consuming than the E-DCH.

Thus, without any means to report the E-DCH needs to the CRNC, it could happen that DCH receive an unfair portion of the available resources. This is particularly disturbing, because it means that a user with an “old-fashioned” user equipment without the E-DCH capability could receive better performance than the high-tech device with the E-DCH implemented. It is also noted that a DCH is less efficient compared to E-DCH, so among equally prioritised users, the E-DCH users should be prioritised.

A particular challenge of for this resource balancing problem comes with the Guaranteed Bit rate (GBR) users, which may be supported over both DCH and E-DCH (again, depending on UE capability). Thus, there is a need to make sure that the requests by the E-DCH GBR users can be fulfilled. An existing solution to the problem is to configure dedicated buffer measurements, both for DCH and E-DCH users, over the Uu interface, which is the radio interface between the UTRAN and the user equipment utilizing WCDMA. This would facilitate an evaluation of the resource needs of the different users—and to balance the load between DCH and E-DCH. However, this solution has some major drawbacks: It introduces a significant amount of additional traffic over the already loaded air-interface (measurement reports) and it is expected to be too slow, because measurements cannot be sent too frequently. The present invention provides a different solution to the resource problem, where the problems of prior art are alleviated.

### SUMMARY OF THE INVENTION

It is an objective with the present invention to provide an improved system for balancing load between at least two groups of dedicated uplink channels in a telecommunication network serving a plurality of user equipments.

This objective is achieved through a system according to the characterising portion of claim 1.

Another objective with the present invention is to provide an improved arrangement in a radio base station for balancing load between at least two groups of dedicated uplink channels in a telecommunication network serving a plurality of user equipments.

This other objective is achieved through providing an arrangement according to the characterising portion of claim 15.

Still another objective with the present invention is to provide an improved arrangement in a radio network controller unit for balancing load between at least two groups of dedicated uplink channels in a telecommunication network serving a plurality of user equipments.

This other objective is achieved through providing an arrangement according to the characterising portion of claim 28.

A further objective with the present invention is to provide an improved method for balancing load between at least two groups of dedicated uplink channels in a telecommunication network serving a plurality of user equipments.

This further objective is achieved through providing a method according to the characterising portion of claim 37.

Thanks to the provision of a system and a method, which enables coordination between the RNC resource management and the Node B scheduling function, an improved overall radio resource management for both E-DCH and DCH users is obtained. In particular, the invention provides means for doing fair resource sharing of E-DCH and non-E-DCH users, means for avoiding situations, where less capable user equipments receive better QoS than new E-DCH capable user equipments, and means for assuring that prioritised E-DCH users receive the requested resources.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows the telecommunication network architecture according to the present invention;

FIG. 2 is a flowchart showing the inventive method steps.

### DETAILED DESCRIPTION OF PREFERRED EMBODIMENTS

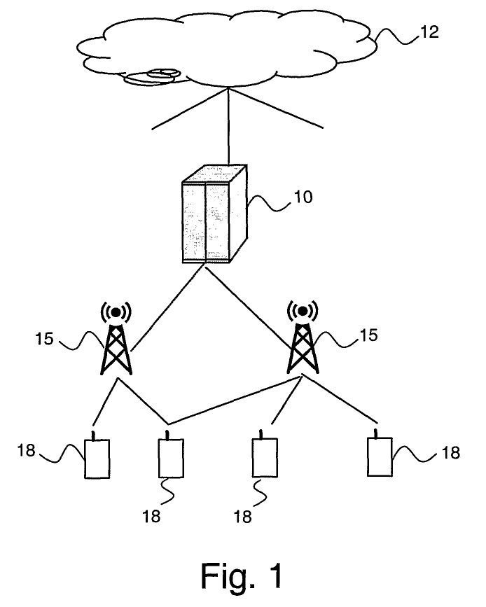

A network according to a standard like 3GPP comprises a Core Network (CN), Radio Access Networks (RAN) and User Equipments (UE) attached to a RAN, such as the UMTS Terrestrial Radio Access Network (UTRAN) architecture. FIG. 1 shows an exemplary network like this, wherein the UTRAN comprises one or more Radio Network Controllers (RNCs) 10 and one or more Node B 15 (Radio Base Stations) which are connected to the RNC 10 through the lub-interface. A Controlling Radio Network Controller (CRNC) (not specifically shown) is the RNC responsible for the configuration of a particular Node B. Thus, a user equipment accessing the system will send an access message to a Node B, which in turn will forward this message on to its CRNC. The UTRAN connects to the core network 12 through the lu-interface. The UTRAN and the CN 12 provide communication and control for a plurality of user equipments 18.

Node B 15 is the function within the UTRAN that provides the physical radio link between the user equipments 18 and the network. Along with the transmission and reception of data across the radio interface the Node B 15 also applies the codes that are necessary to describe channels in a CDMA system. In Node B 15, there is provided a scheduler which controls when an E-DCH user equipment is transmitting and at what data rate.

In the uplink direction, several channels from each UE 18 will be transmitted with the introduction of the enhanced uplink. The Dedicated Physical Control Channel (DPCCH) carries pilot symbols and parts of the outband control signalling. Remaining outband control signalling for the enhanced uplink is carried on the Enhanced Dedicated Physical Control Channel (E-DPCCH) which is a new control channel, while the Enhanced Dedicated Physical Data Channel (E-DPDCH) carries the data transmitted using the enhanced uplink features.

A scheduling request is control information that is transmitted from the user equipments to the scheduler located in the Node B. The scheduling request provides the scheduler with information on the resource requirement in the user equipments. The scheduler divides the available resources among the users and informs the user equipments by transmitting scheduling grants. As a basic concept the present invention introduces means to process and report measurements of scheduling requests and scheduling grants, as seen by the Node B. Based on requested measurement configuration, these measurements are then forwarded to the RNC, so that the RNC can do load balancing between DCH and E-DCH users. The proposed measurements can be either on a cell-level, or on a per-user level. The latter solution is particularly suited for Guaranteed Bit Rate (GBR) traffic. This implies thus the necessity of certain measurements from the Node B to the RNC and control commands from the RNC to the Node B needed for efficient resource control of E-DCH.

Assume a cell with a heavy uplink load offered by both DCH and E-DCH users. With known measurements and resource control tools the uplink could be configured to fully utilize the available interference resource. The E-DCH could be scheduled to utilize the interference remaining from Non-E-DCH use. However, the interference-measurements between Node B and CRNC do not include any information on the offered load by E-DCH users. Thus, the CRNC cannot judge on any mismatch between E-DCH power allocation and E-DCH power needs. Provided CRNC would be aware of such a mismatch, it could issue a re-scheduling of DCH users, e.g. by limiting the Transport Format Combination Set (TFCS) of DCH channels, which would allow for a re-distribution of resources to E-DCH channels.

The present invention defines measurements indicating scheduling request versus scheduling grant mismatch for E-DCH users and facilitates by this means the resource re-distribution from the CRNC. Particular applications of the invention include measuring the aggregated number of scheduling requests in the cell, and comparing this value to the number of scheduling grants. The measurement could include the ratio of scheduling requests versus scheduling grants. Thus, according to a preferred embodiment of the invention a system for balancing load between at least two groups of dedicated uplink channels in a telecommunication network serving a plurality of user equipments 18 comprises at least one Node B 15 arranged to communicate with said user equipments 18 and at least one RNC 10 arranged to control radio network resources. The at least one Node B 15 comprises means for measuring scheduling requests received from said user equipments 18, means for measuring scheduling grants issued to said user equipments 18, means for deriving a measurement report based on said measured scheduling requests and said measured scheduling grants, and means for forwarding said measurement report to the CRNC 10. The at least one RNC 10 comprises means for receiving the measurement report from the Node B and means for re-distributing available radio resources between the at least two groups of dedicated uplink channels.

According to a preferred embodiment of the present invention said means for measuring scheduling requests is arranged to measure a number of scheduling requests received from said user equipments during a pre-determined period of time and said means for measuring scheduling grants is arranged to measure a number of scheduling grants issued to said user equipments during said pre-determined period of time. Said measurement report comprises a ratio of said measured number of scheduling requests and said measured number of scheduling grants.

The scheduling requests may comprise information of a buffer status in the user equipments and which priorites data traffic sent from the user equipments have. This information is used according to another preferred embodiment of the invention to derive the measurement report, i.e the measurement report comprises a comparison between a buffer status in the user equipments provided in the scheduling requests and the scheduling grant accepted by Node B and/or information of which priority the scheduling request from a user equipment refers to. The Radio Resource Control (RRC) configures for each priority a threshold value in a number of Transmission Time Interval (TTI) or in seconds. A flow is defined to be unsatisfied if the transmit buffer according to the scheduling request not can be emptied within the number of TTI with the maximum possible scheduling grants issued given current resources. Node B reports to the CRNC periodically or event triggered: which priority the highest priority “unsatisfied” flow has; the total number of “unsatisfied” flows; and, the ratio of “unsatisfied” flows with the highest priority. Alternatively the Node B reports the identity of the “unsatisfied” flows. Further the report may contain an estimate on additional resources needed in order to fulfil the requirements. This may be reported per flow, per priority or in total. If E-DCH users with higher priority than DCH users are “unsatisfied” the CRNC uses the report to reallocate appropriate amount of resources.

The scheduling request may comprise a happy-bit that is set if the user equipment is provided with enough radio resources. According to still another embodiment of the invention, a measurement report is derived containing the number of users that are unhappy for a pre-determined period of time, i.e. the happy-bit is not set in the scheduling requests from these users.

One conceivable embodiment of the invention is to configure a threshold at the Node B 15 (from the RNC) and a period, where the period time over which the measurements should be performed and the threshold indicates at which ratio of the scheduling requests versus scheduling grants the Node B must report the value to the RNC.

For GBR users, the RNC 10 could configure the same threshold and period for a single user. This would facilitate the monitoring of whether the E-DCH GBR users are receiving the service they demand.

According to another preferred embodiment of the invention, a particular solution would be to configure such measurements for certain groups of users, e.g. for GBR or otherwise prioritised traffic.

In still another embodiment of the invention, a threshold is configured, so that the Node B 15 always reports to the RNC 10 if a scheduling request cannot be fulfilled.

The methods and devices according to the present invention include in the Node B a measurement function and an entity for processing the measurements. Correspondingly, for the RNC the present invention includes function and devices for configuring the measurements a device in the RNC for processing the measurements received from the Node B, and the methods for controlling the resource distribution between DCH and EDCH users.

Thus, the arrangement in Node B 15 according to a preferred embodiment of the present invention for balancing load between at least two groups of dedicated uplink channels in a telecommunication network serving a plurality of user equipments 18, comprises: means for measuring scheduling requests received from said user equipments 18, means for measuring scheduling grants issued to said user equipments 18, means for deriving a measurement report based on said measured number of scheduling requests and said measured number of scheduling grants, and means for forwarding said measurement report to the CRNC 10 controlling radio network resources, whereby the CRNC 10 is arranged to re-distribute available radio resources between said at least two groups of dedicated uplink channels.

And, the arrangement in the CRNC 10 according to a preferred embodiment of the present invention for balancing load between at least two groups of dedicated uplink channels in a telecommunication network serving a plurality of user equipments 18, comprises means for receiving measurement reports from one or more Node B:s 15 based on measured scheduling requests from said user equipments 18 in the Node B:s 15 and measured scheduling grants accepted by the Node B:s 15, and means for re-distributing available radio resources between said at least two groups of dedicated uplink channels.

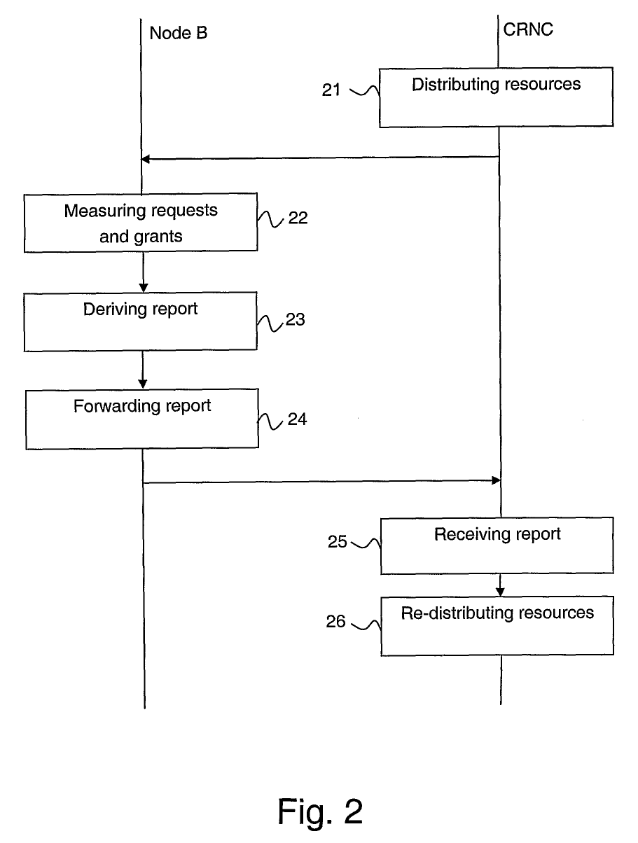

In a preferred embodiment of the present invention, the procedure in the Node B 15 for balancing load between at least two groups of dedicated uplink channels in a telecommunication network serving a plurality of user equipments 18, shown in FIG. 2 on the left hand side, is as follows:
measuring scheduling requests received from the user equipments 18 and measuring a scheduling grants issued to the user equipments 18, i.e. scheduling grants accepted by the Node B 15 (step 22);
deriving a measurement based on the measured scheduling requests and the measured scheduling grants (step 23). Preferably; the measurement report includes the ratio of a number of scheduling requests versus a number of scheduling grants counted during a pre-determined period of time. The measurement report may also comprise requested resources versus available resources, a buffer status provided in the scheduling request in the user equipments versus scheduling grants and/or the priority of the data traffic sent from the user equipment provided in the scheduling requests;
forwarding said measurement report to the RNC 10 controlling radio network resources (step 24), whereby a re-distribution of available radio resources is made between said at least two groups of dedicated uplink channels. Preferably, a threshold value is configured in the Node B 15 and the measurement report is forwarded to the CRNC 10 when the ration of scheduling requests versus scheduling grants exceeds this threshold value.

In a preferred embodiment of the present invention, the procedure in the RNC 10 for balancing load between at least two groups of dedicated uplink channels in a telecommunication network serving a plurality of user equipments 18, shown in FIG. 2 on the right hand side, is as follows:
distributing radio resources between at least two groups of dedicated uplink channels, such as E-DCH and DCH (step 21);
receiving measurement reports from one or more Node B 15 based on measured scheduling requests from the user equipments 18 in the Node B 15 and measured scheduling grants accepted by the Node B (step 25);
re-distributing available radio resources between the at least two groups of dedicated uplink channels (step 26).

1. A system for balancing load between at least two groups of dedicated uplink channels in a telecommunication network serving a plurality of user equipments, characterised in that the system comprises at least one first radio network unit arranged to communicate with said user equipments and at least one second radio network unit arranged to control radio network resources, said at least one first radio network unit comprising:
means for measuring scheduling requests received from said user equipments;
means for measuring scheduling grants issued to said user equipments;
means for deriving a measurement report based on said measured scheduling requests and said measured scheduling grants;
means for forwarding said measurement report to said at least one second radio network unit;
and, said at least one second radio network unit comprising:
means for receiving said measurement report from said at least one first radio network unit; and,
means for re-distributing available radio resources between said at least two groups of dedicated uplink channels.

2. A system according to claim 1, characterised in that said means for measuring scheduling requests is arranged to measure a number of scheduling requests received from said user equipments during a pre-determined period of time and said means for measuring scheduling grants is arranged to measure a number of scheduling grants issued to said user equipments during said pre-determined period of time.

3. A system according to claim 2, characterised in that said measurement report comprises a ratio of said measured number of scheduling requests and said measured number of scheduling grants.

4. A system according to claim 3, characterised in that said at least one first radio network unit comprises means for configuring a threshold value, whereby said measurement report is forwarded when said ratio exceeds said threshold value.

5. A system according to claim 1, characterised in that said measurement report is forwarded periodically.

6. A system according to claim 1, characterised in that said scheduling request comprises a resource request from a user equipment and said derived measurement report further comprises a comparison between said resource request and available resources.

7. A system according to claim 1, characterised in that said scheduling request comprises information of a buffer status in said user equipment and said measurement report comprises a comparison between said buffer status and said measured scheduling grant issued to said user equipment.

8. A system according to claim 1, characterised in that said measurement report comprises information of which priority the scheduling request from a user equipment refers to.

9. A system according to claim 1, characterised in that said at least two groups of dedicated uplink channels are Enhanced Dedicated Channels (E-DCH) scheduled from said at least one first radio network unit and Dedicated Channels (DCH) scheduled from said at least one second radio network unit.

10. A system according to claim 1, characterised in that said first radio network unit is a Radio Base Station.

11. A system according to claim 1, characterised in that said second radio network unit is a Controlling Radio Network Controller (CRNC).

12. A system according to claim 1, characterised in that said telecommunications network is a Wideband Code-Division Multiple Access (WCDMA) network.

13. A system according to claim 1, characterised in that said at least two groups of dedicated channels include dedicated channels requiring a certain level of Quality of Service.

14. A system according to claim 1, characterised in that said at least two groups of dedicated channels include dedicated channels comprising prioritised data traffic.

15. An arrangement in a radio base station for balancing load between at least two groups of dedicated uplink channels in a telecommunication network serving a plurality of user equipments, characterised in that the arrangement comprises:
means for measuring scheduling requests received from said user equipments;
means for measuring scheduling grants issued to said user equipments;
means for deriving a measurement report based on said scheduling requests and said measured number of scheduling grants; and,
means for forwarding said measurement report to a superior radio network unit controlling radio network resources, wherein said superior radio network unit is arranged to re-distribute available radio resources between said at least two groups of dedicated uplink channels.

16. An arrangement according to claim 15, characterised in that said means for measuring scheduling requests is arranged to measure a number of scheduling requests received from said user equipments during a pre-determined period of time and said means for measuring scheduling grants is arranged to measure a number of scheduling grants issued to said user equipments during said pre-determined period of time.

17. An arrangement according to claim 16, characterised in that said measurement report comprises a ratio of said measured number of scheduling requests and said measured number of scheduling grants.

18. An arrangement according to claim 17, characterised in that said arrangement further comprises means for configuring a threshold value, whereby said measurement report is forwarded when said ratio exceeds said threshold value.

19. An arrangement according to claim 15, characterised in that said measurement report is forwarded periodically.

20. An arrangement according to claim 15, characterised in that said scheduling request comprises a resource request from a user equipment and said derived measurement report further comprises a comparison between said resource request and available resources.

21. An arrangement according to claim 15, characterised in that said scheduling request comprises information of a buffer status in said user equipment and said measurement report comprises a comparison between said buffer status and said measured scheduling grant issued to said user equipment.

22. An arrangement according to claim 15, characterised in that said measurement report comprises information of which priority the scheduling request from a user equipment refers to.

23. An arrangement according to claim 15, characterised in that said at least two groups of dedicated uplink channels are Enhanced Dedicated Channels (E-DCH) scheduled from said radio base station and Dedicated Channels (DCH) scheduled from said superior radio network unit.

24. An arrangement according to claim 15, characterised in that said superior radio 30 network unit is a Controlling Radio Network Controller (CRNC).

25. An arrangement according to claim 15, characterised in that the telecommunications network is a Wideband Code-Division Multiple Access (WCDMA) network.

26. An arrangement according to claim 15, characterised in that said at least two groups of dedicated channels include dedicated channels requiring a certain level of Quality of Service.

27. An arrangement according to claim 15, characterised in that said at least two groups of dedicated channels include dedicated channels comprising prioritised data traffic.

28. An arrangement in a radio network controller (RNC) unit for balancing load between at least two groups of dedicated uplink channels in a telecommunication network serving a plurality of user equipments characterised in that the arrangement comprises:
means for receiving measurement reports from one or more radio base stations based on measured scheduling requests from said user equipments in said radio base station(s) and measured scheduling grants accepted by said radio base station(s); and,
means for re-distributing available radio resources between said at least two groups of dedicated uplink channels.

29. An arrangement according to claim 28, characterised in that said measurement report comprises a ratio of measured number of scheduling requests and measured number of scheduling grants.

30. An arrangement according to claim 28, characterised in that said measurement reports comprise a comparison between resource requests of said user equipments provided in said measured scheduling requests and available resources.

31. An arrangement according to claim 28, characterised in that said measurement reports comprise a comparison between a buffer status in said user equipments provided in said measured scheduling requests and said measured scheduling grant accepted by said radio base station(s).

32. An arrangement according to claim 28, characterised in that said measurement report comprises information of which priority the scheduling request from a user equipment refers to.

33. An arrangement according to claim 28, characterised in that said at least two groups of dedicated uplink channels are Enhanced Dedicated Channels (E-DCH) scheduled from said radio base station(s) and Dedicated Channels (DCH) scheduled from said radio network controller unit.

34. An arrangement according to claim 28, characterised in that the telecommunications network is a Wideband Code-Division Multiple Access (WCDMA) network.

35. An arrangement according to claim 28, characterised in that said at least two groups of dedicated channels include dedicated channels requiring a certain level of Quality of Service.

36. An arrangement according to claim 28, characterised in that said at least two groups of dedicated channels include dedicated channels comprising prioritised data traffic.

37. A method for balancing load between at least two groups of dedicated uplink channels in a telecommunication network serving a plurality of user equipments, characterised by the steps of:
measuring scheduling requests received from said user equipments;
measuring scheduling grants issued to said user equipments;
deriving a measurement report based on said measured scheduling requests and said measured scheduling grants; and,
forwarding said measurement report to a radio network unit controlling radio network resources, whereby a re-distribution of available radio resources is made between said at least two groups of dedicated uplink channels.

38. A method according to claim 37, characterised in that the method further comprises the steps of:
measuring a number of scheduling requests from said user equipments during a predetermined period of time;
measuring a number of scheduling grants issued to said user equipments during said pre-determined period of time; and,
comparing said measured number of scheduling requests with said measured number of scheduling grants.

39. A method according to claim 37, characterised in that the method further comprises the step of configuring a threshold value, whereby said measurement report is forwarded when said ratio exceeds said threshold value.

40. A method according to claim 37, characterised in that said measurement report is forwarded periodically.

41. A method according to claim 37, characterised in that the method further comprises the step of comparing resource requests provided in said measured scheduling request with available resources.

42. A method according to claim 37, characterised in that the method further comprises the step of comparing a buffer status in said user equipments provided in said measured scheduling requests with said measured scheduling grant.
